(19) United States
(12) Patent Application Publication
(10) Pub. No.: US 2007/0050784 A1
(43) Pub. Date: Mar. 1, 2007

(54) Optical disk drive

(75) Inventors: Tsukasa Shinmi, Osaka (JP); Shinya Tanaka, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/507,651

(22) Filed: Aug. 22, 2006

(30) Foreign Application Priority Data
Aug. 22, 2005 (JP) 2005-239572

(51) Int. Cl. G11B 17/04

(52) U.S. Cl. 720/604

(57) ABSTRACT

An optical disk drive includes a turntable, a clamp and a motor for driving the turntable to rotate. An optical disk is held in such a way that it is sandwiched between the turntable and the clamp. The turntable, which is made of a magnetic metal plate by a drawing process, includes an optical disk placement portion for placing an optical disk and a protruding portion that protruded from the center of the optical disk placement portion in the axial direction.

This application is based on Japanese Patent Application No. 2005-239572 filed on Aug. 22, 2005, the contents of which are hereby incorporated by reference.

### BACKGROUND OF THE INVENTION

1. Field of the Invention

The present invention relates to an optical disk drive for writing and reading data on an optical disk by irradiating the optical disk with a laser beam. In particular, the present invention relates to an optical disk drive that is capable of holding the optical disk securely.

2. Description of Related Art

Optical disks are used as recording media for recording and/or reading information such as picture data or sound data by irradiating the optical disk with a laser beam. As an optical disk, a CD (Compact Disc), a DVD (Digital Versatile Disc) or the like is used widely. An optical disk drive that uses such an optical disk as a recording medium rotates the optical disk and irradiates a recording surface of the optical disk with a laser beam, so as to read out information recorded on the optical disk or to record information on a recordable optical disk.

As a conventional example of this optical disk drive, there is one described in JP-A-2002-329357. FIG. 3 is a cross sectional view showing an example of an optical disk drive mechanism equipped to the conventional optical disk drive. A optical disk drive mechanism 91 shown in FIG. 3 includes a turntable 92 and a clamp 93 that retains the optical disk Ds between the turntable 92 and the clamp 93. The turntable 92 is made of an integrally-molded plastic, which is fixed to a drive shaft 941 of a motor 94. The turntable 92 is driven by the motor 94 so as to rotate.

The turntable 92 shown in FIG. 3 includes an optical disk placement portion 921 on which the optical disk Ds is placed, a through portion 922 that fits in an engaging hole formed at the center of the optical disk Ds, an insertion hole 923 formed in the through portion 922 and a damper yoke 924 that receives a magnetic force (an attracting force) from a permanent magnet 932 fixed to the clamp 93. A through hole 925 is formed at the center of the turntable 92, and the drive shaft 941 of the motor 94 is fitted in the through hole 925 to be fixed.

The bottom face of the insertion hole 923 of the turntable 92 is provided with a plurality of bosses 926, while the damper yoke 924 is provided with boss holes 9241 at positions corresponding to the bosses 926. The damper yoke 924 is set in the insertion hole 923 so that the bosses 926 penetrate the boss holes 9241, and then tips of the bosses 926 are heated to melt. When the melted resin is hardened, the damper yoke 924 is fixed in the insertion hole 923. By this fusing and fixing, a drop off of the damper yoke 924 from the insertion hole 923 can be prevented.

The drive shaft 941 of the motor 94 is fixed by press fit in the through hole 925. The turntable 92 is made of a resin while the drive shaft 941 is made of a metal. Therefore, the fixed state between the drive shaft 941 and the through hole 925 of the turntable 92 may become unstable due to a difference of expansion or contraction rate between them when environment such as temperature or humidity changes. In order to avoid this unstable fixed state, the drive shaft 941 is fixed to the turntable 92 in the through hole 925 using an adhesive. A groove is formed on the drive shaft 941, and the adhesive is filled in the groove. Then, the drive shaft 941 is pressed to fit in the through hole 925. In this way, migration of the adhesive is avoided during the press fit, and the drive shaft 941 is securely fixed to the turntable 92 using the adhesive.

As shown in FIG. 3, the clamp 93 includes a presser portion 931 and a damper magnet 932. The presser portion 931 includes a pressing face 9311 that presses the upper face of the optical disk Ds and an engaging recess 9312 that engages the through portion 922 of the turntable 92. The damper magnet 932 has a ring-like shape, which is fixed to the engaging recess 9312 securely so that it does not drop off.

The motor 94 and the turntable 92 are attached to a traverse chassis. When the optical disk is inserted, the traverse chassis rises so that the optical disk Ds is lifted by the turntable 92. After that, the optical disk Ds is held between the turntable 92 and the clamp 93. On this occasion, the optical disk Ds is securely held between the turntable 92 and the clamp 93 by a magnetic force (an attracting force) generated between the damper magnet 932 and the damper yoke 924.

In order to press the drive shaft 941 to fit in the through hole 925 of the turntable 92 and to adhere them to each other in the conventional optical disk drive as described above, it is necessary to form a groove on the drive shaft 941 for preventing migration of the adhesive during the press fit as described above. In addition, although the turntable 92 and the drive shaft 941 are adhered to each other, the adhered state between the turntable 92 and the drive shaft 941 may become unstable when the temperature, humidity or other environment changes and the adhesive becomes melted.

In addition, when the damper yoke 924 is fixed in the insertion hole 923 of the turntable 92, the damper yoke 924 is set so that the bosses 926 formed in the insertion hole 923 penetrate the boss holes 9241 formed on the damper yoke 923, and the bosses 926 are fused and fixed. Therefore, the positioning of the damper yoke 924 as well as the fusing of the bosses 926 takes much labor and time.

In addition, in order to hold the optical disk between the clamp 93 and the turntable 92, a magnetic force (an attracting force) is utilized, which works between the damper magnet 932 attached to the clamp 93 and the damper yoke 924 attached to the turntable 92. This magnetic force may give a bad influence to the motor 94. More specifically, the motor 94 has a structure in which a coil rotates in a magnetic field generated by the permanent magnet. Therefore, if another magnetic field works externally, an accuracy of rotation may be decreased.

### SUMMARY OF THE INVENTION

An object of the present invention is to provide an optical disk drive with a clamp mechanism for holding an optical disk between a clamp and a turntable to drive the same, which can be manufactured in a short time at a low cost by reducing the number of components and manufacturing steps.

Another object of the present invention is to provide an optical disk drive with a clamp mechanism for holding an optical disk between a clamp and a turntable to drive the same, which can reduce an influence of the magnetic force that works between the clamp and the turntable to the motor without using a special member, so that the motor can rotate stably and smoothly with a high accuracy.

According to a first aspect of the present invention, an optical disk drive for recording or reading data on an optical disk by irradiating the optical disk with a laser beam is provided. It includes a turntable for supporting and rotating the optical disk, a clamp for holding the optical disk in such a way that the optical disk is sandwiched between the turntable and the clamp, and a motor for driving the turntable to rotate. The turntable, which is structured to press the recording face side of the optical disk so that the optical disk is sandwiched between the clamp and the turntable when the optical disk is inserted, includes an optical disk placement portion for placing the optical disk, a protruding portion that protrudes from the center of the optical disk placement portion, and a plastic holding portion that is fixed to the outer face of the protruding portion and engages a center hole of the optical disk. A plurality of bosses provided to the holding portion are inserted into a plurality of boss holes provided to the optical disk placement portion, and tip portions of the bosses are fused so that the holding portion is fixed to the optical disk placement portion. The clamp includes a presser portion with a pressing face that contacts with a side of the optical disk opposite to the side that contacts with the turntable, an engaging recess that engages the holding portion and a ring-like damper magnet that is fixed to the engaging recess. The optical disk placement portion and the protruding portion of the turntable are made of a magnetic metal plate integrally by a drawing process, and a drive shaft of the motor is pressed to fit in and fixed to the turntable.

According to this structure, the optical disk placement portion and the protruding portion of the turntable are made of a metal plate by a drawing process, so the process for manufacturing the component is easier than integral molding of a plastic.

In addition, since the protruding portion is made of a magnetic metal plate by a drawing process, a yoke that is attached to the turntable in the conventional structure becomes needless. Thus, structural members can be reduced.

In addition, since the optical disk placement portion of the turntable is made of a magnetic metal plate, a magnetic field formed by the damper magnet that is provided to the clamp can be shielded when the optical disk is sandwiched between the clamp and the turntable so that an influence of the magnetic field to the motor is suppressed.

According to a second aspect of the present invention, an optical disk drive for recording or reading data on an optical disk by irradiating the optical disk with a laser beam is provided. It includes a turntable for placing and rotating the optical disk, a clamp for holding the optical disk in such a way that the optical disk is sandwiched between the turntable and the clamp, and a motor for driving the turntable to rotate. The turntable, which is structured to press the recording face side of the optical disk so that the optical disk is sandwiched between the clamp and the turntable when the optical disk is inserted, includes an optical disk placement portion for placing the optical disk, a protruding portion that protrudes from the center of the optical disk placement portion, and a plastic holding portion that is fixed to the outer face of the protruding portion and engages a center hole of the optical disk, a plurality of bosses provided to the holding portion are inserted into a plurality of boss holes provided to the optical disk placement portion, and tip portions of the bosses are fused so that the holding portion is fixed to the optical disk placement portion. The clamp includes a presser portion with a pressing face that contacts with a side of the optical disk opposite to the side that contacts with the turntable, an engaging recess that engages the holding portion and a ring-like damper magnet that is fixed to the engaging recess. The optical disk placement portion and the protruding portion of the turntable are made of a magnetic metal integrally, and a drive shaft of the motor is pressed to fit in and fixed to the turntable.

According to this structure, the optical disk placement portion and the protruding portion of the turntable are made of a magnetic metal integrally, so the process for manufacturing the component is easier than integral molding of a plastic.

In addition, since the protruding portion is made of a magnetic metal, a yoke that is attached to the turntable in the conventional structure becomes needless. Thus, structural members can be reduced.

In addition, since the optical disk placement portion of the turntable is made of a magnetic metal, a magnetic field formed by the damper magnet that is provided to the clamp can be shielded when the optical disk is sandwiched between the clamp and the turntable so that an influence of the magnetic field to the motor is suppressed.

In the above-mentioned structure, it is preferable that the optical disk placement portion and the protruding portion of the turntable be made of a magnetic metal plate integrally by a drawing process. In addition, instead of the drawing process, other processes for shaping a magnetic metal may be adopted widely.

According to the present invention, it is possible to provide an optical disk drive including a clamp mechanism for holding an optical disk between a clamp and a turntable to rotate the same, which can be manufactured in a short time at a low cost by reducing the number of components and manufacturing steps.

In addition, according to the present invention, it is possible to provide an optical disk drive including a clamp mechanism for holding an optical disk between a clamp and a turntable to rotate the same, which can reduce an influence of the magnetic force that works between the clamp and the turntable to the motor without using a special member, so that the motor can rotate stably and smoothly with a high accuracy.

### BRIEF DESCRIPTION OF THE DRAWINGS

FIG. 1 is a block diagram showing a structure of an optical disk drive according to an example of the present invention.

FIG. 2 is a cross sectional view showing an example of an optical disk drive mechanism that is provided to the optical disk drive according to the example of the present invention.

FIG. 3 is a cross sectional view of an optical disk drive mechanism that is provided to a conventional optical disk drive.

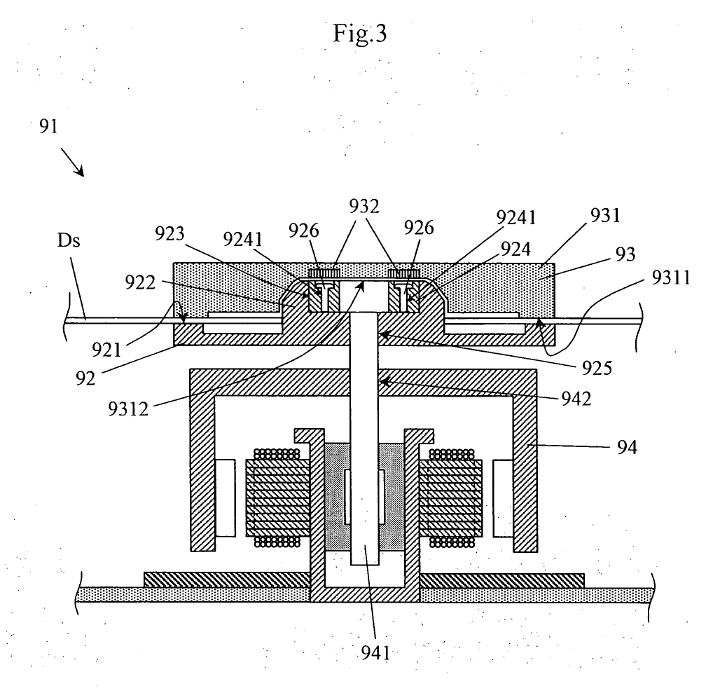

### DESCRIPTION OF THE PREFERRED EMBODIMENTS

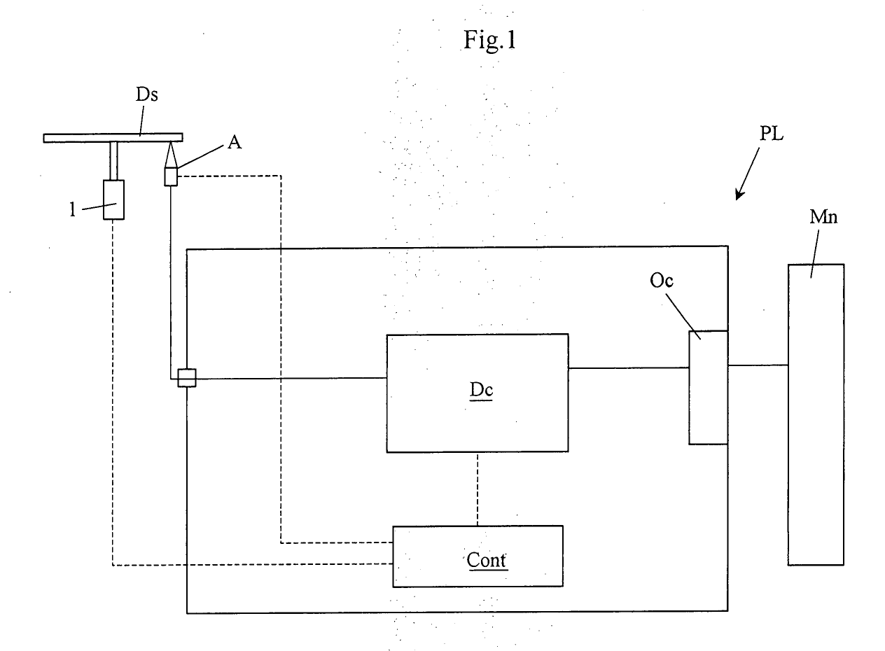

Now, an example of the present invention will be described with reference to the attached drawings. FIG. 1 is a block diagram showing a structure of an optical disk drive according to the example of the present invention. The optical disk drive shown in FIG. 1 is a DVD player, but an application of the present invention is not limited to a DVD player. A DVD player PL shown in FIG. 1 includes an optical disk drive mechanism 1 for rotating an optical disk (a DVD recording medium) Ds, an optical head A for reading information from the optical disk Ds by irradiating the optical disk Ds with a light beam, a decoder Dc for decoding a signal detected by the optical head A, an external connection portion Oc for connection with a monitor Mn that is an external display device and a control portion Cont.

The DVD player PL is controlled by the control portion Cont. When a user issues a command for reproducing information recorded on a DVD, the optical disk drive mechanism 1 first drives the optical disk Ds to rotate. The rotating optical disk Ds is irradiated with a laser beam emitted from the optical head A, and its reflection light is detected by the optical head A. The optical head A includes a light reception element for transforming the detected light into an electric signal, and its output electric signal is sent to the decoder Dc. The decoder Dc decodes the input electric signal into a video signal, which is sent to the monitor Mn via the external connection portion Oc. The monitor Mn displays a picture in accordance with the given video signal.

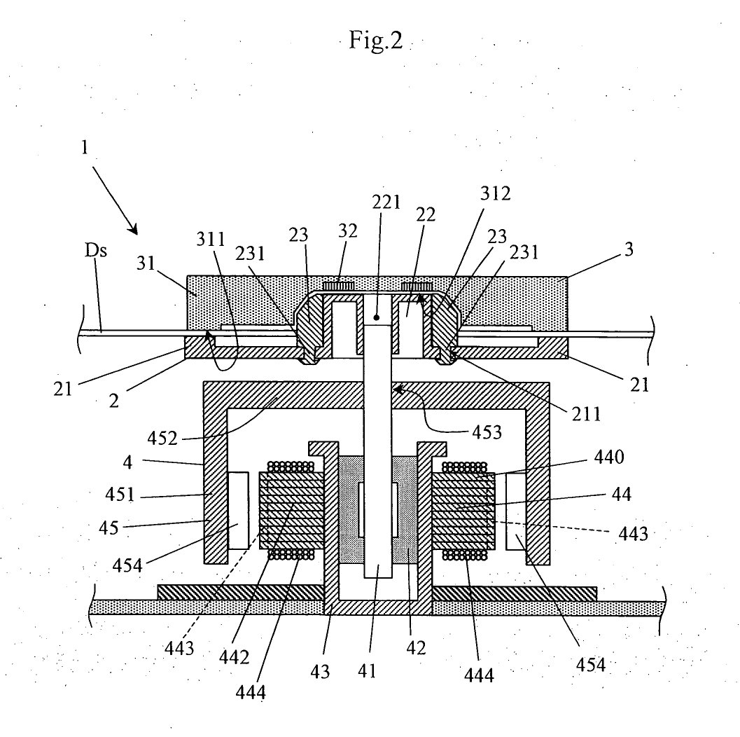

FIG. 2 is a cross sectional view showing an example of an optical disk drive mechanism that is provided to the optical disk drive according to the example of the present invention. The optical disk drive mechanism 1 shown in FIG. 2 includes a turntable 2 for supporting the optical disk Ds, a clamp 3 for holding the optical disk Ds in such a way that the optical disk Ds is sandwiched between the turntable 2 and the clamp 3, and a motor 4 for rotating the turntable 2.

As shown in FIG. 2, the turntable 2 includes an optical disk placement portion 21 for placing the optical disk Ds, a protruding portion 22 that protrudes from the center of the optical disk placement portion 21 in the axial direction, and a plastic holding portion 23 that is fixed to the outer face of the protruding portion 22 and engages a center hole of the optical disk Ds.

The optical disk placement portion 21 and the protruding portion 22 of the turntable 2 are made of a magnetic metal plate integrally by a drawing process. However, the present invention is not limited to this structure. The optical disk placement portion 21 is provided with a plurality of boss holes 211 that are arranged in a predetermined pitch in a circumferential direction around the center axis of the turntable 2. The holding portion 23 is made of a plastic (resin) so that the inner edge portion of the optical disk Ds is not chipped when the holding portion 23 engages the center hole of the optical disk Ds. However, the present invention is not limited to this structure.

A face of the holding portion 23 that contacts with the optical disk placement portion 21 is provided with a plurality of bosses 231. The plurality of bosses 231 are formed on positions corresponding to the positions of the boss holes 211 formed in the optical disk placement portion 21. The holding portion 23 is set to engage the outside of the protruding portion 22 in such a way that the plurality of bosses 231 are inserted in the corresponding boss holes 211, and then tip portions of the bosses 231 protruding from the boss holes 211 are heated and fused so that the holding portion 23 is fixed to the optical disk placement portion 21 and the protruding portion 22. An insertion hole 221 is formed in the center of the protruding portion 22, so that a rotation shaft 41 of the motor 4 that will be described later is inserted in the insertion hole 221.

The motor 4 includes a rotation shaft 41 that is fixed to the turntable 2, a bearing 42 for retaining the rotation shaft 41 in a rotatable manner, a housing 43 that houses the bearing 42, a laminated core 44 that is fixed to the outside of the housing 43 and a cylindrical rotor 45 that is fixed to the rotation shaft 41. Although a type of a plain bearing is shown as the bearing 42 in FIG. 2, the bearing 42 is not limited to this structure. Various types of bearings that can support the rotation shaft 41 so that it can rotate stably may be adopted. In addition, the rotation shaft 41 is pressed to fit in the insertion hole 221 formed in the protruding portion 22 of the turntable 2, and the rotation shaft 41 is fixed to the turntable 2 securely.

The laminated core 44 includes nine coil winding portions 442 protruding from a cylindrical portion outward in the radial direction. The coil winding portions 442 are arranged at a predetermined interval in the circumferential direction. A peripheral portion of the coil winding portions 442 is provided with an edge plate 443 extending in the circumferential direction. Coils 444 are wound around the coil winding portions 442. The laminated core 44 is made of a plurality of metal core plates 440 laminated and glued with insulators between neighboring core plates 440. Since the insulator is sandwiched between neighboring core plates 440 for the lamination, generation of eddy current can be reduced so that energy loss can be reduced.

The rotor 45 includes a cylindrical curved face portion 451 and a flat face portion 452 that closes an end of the curved face portion 451, and a through hole 453 is formed at the center of the flat face portion 452. The rotation shaft 41 is pressed to fit in the through hole 453 to be fixed. A permanent magnet 454 is fixed to the inside of the curved face portion 451.

When a plurality of coils 444 wound around the coil winding portions 442 of the laminated core 44 are supplied with electric current at a predetermined timing sequentially, a rotating magnetic field is generated. The permanent magnet 454 rotates in synchronization with the rotating magnetic field, so that the rotor 45 rotates. The rotation of the rotor 45 rotates the turntable 2 via the rotation shaft 41, so that the optical disk Ds supported and held on the turntable 2 rotates.

The clamp 3 includes a presser portion 31 and a damper magnet 32 as shown in FIG. 2. The presser portion 31 includes a pressing face 311 that contacts with the upper surface of the optical disk Ds and an engaging recess 312 that engages the holding portion 23 that is fixed to the turntable 2. The damper magnet 32 has a ring-like shape and is fixed to the engaging recess 312 securely so that it does not drop off.

The clamp 3 is supported by a supporting member (not shown) in a rotatable manner. The optical disk Ds is held between the clamp 3 and the turntable 2 securely by a magnetic force (an attracting force) that works between the protruding portion 22 of the turntable 2 made of a magnetic metal plate and the damper magnet 32. Thus, a slip or a slide of the optical disk Ds from the optical disk placement portion 21 of the turntable 2 can be prevented when the turntable 2 starts or stops to rotate.

The operation of the clamp 3 and the turntable 2 when they hold the optical disk Ds between them is as follows. The turntable 2 is attached to the traverse chassis (not shown), and the traverse chassis approaches or retreats with respect to the clamp 3 in accordance with insertion or ejection of the optical disk.

When the optical disk Ds is inserted in the optical disk drive, the traverse chassis approaches to the clamp 3 at a predetermined timing. When the optical disk Ds moves to a data read/write position, the protruding portion 22 and the holding portion 23 of the turntable 2 are inserted in the center hole formed in the optical disk Ds, and the optical disk placement portion 21 lifts the optical disk Ds.

When the traverse chassis further moves, the protruding portion 22 is attracted to the damper magnet 32 by the magnetic force (an attracting force) between the protruding portion 22 made of a magnetic metal plate and the damper magnet 32 of the clamp 3. When the protruding portion 22 is attracted to the damper magnet 32, the optical disk Ds is held securely between the optical disk placement portion 21 of the turntable 2 and the pressing face 311 of the clamp 3 so that it does not slip.

Since the optical disk placement portion 21 and the protruding portion 22 of the turntable 2 are made of a magnetic metal plate integrally, the magnetic field formed by the damper magnet 32 is shielded so as not to affect the motor 4. Thus, operation of the motor 4 is not disturbed by the magnetic field of the damper magnet 32, thereby smooth and accurate drive of the motor 4 can be secured.

Note that the optical disk drive according to the present invention may be a tray type that uses a disk tray for inserting or ejecting an optical disk or may be a slot-in type in which an optical disk is inserted directly into a slot.

Although the optical disk placement portion 21 and the protruding portion 22 of the turntable 2 are made of a magnetic metal plate by a drawing process in the example described above, a method of process is not limited to the drawing process. Various plastic working methods in which a shape after the process is maintained can be adopted widely. In addition, it is possible to combine the optical disk placement portion 21 and the protruding portion 22 made of a metal individually to be one body. Furthermore, it is possible to adopt various methods such as compression molding of a powder material, casting, forging or the like in which the shape of the turntable 2 having ferromagnetism can be formed.

The optical disk drive according to the present invention can be widely used as an optical disk drive for reading or writing information on an optical disk such as a CD or a DVD by irradiating the optical disk with a laser beam.

What is claimed is:

1. An optical disk drive for recording or reading data on an optical disk by irradiating the optical disk with a laser beam, comprising:
a turntable for supporting and rotating the optical disk;
a clamp for holding the optical disk in such a way that the optical disk is sandwiched between the turntable and the clamp: and
a motor for driving the turntable to rotate, wherein
the turntable, which is structured to press the recording face side of the optical disk so that the optical disk is sandwiched between the clamp and the turntable when the optical disk is inserted, includes an optical disk placement portion for placing the optical disk, a protruding portion that protrudes from the center of the optical disk placement portion, and a plastic holding portion that is fixed to the outer face of the protruding portion and engages a center hole of the optical disk, a plurality of bosses provided to the holding portion are inserted into a plurality of boss holes provided to the optical disk placement portion, and tip portions of the bosses are fused so that the holding portion is fixed to the optical disk placement portion,
the clamp includes a presser portion with a pressing face that contacts with a side of the optical disk opposite to the side that contacts with the turntable, an engaging recess that engages the holding portion and a ring-like damper magnet that is fixed to the engaging recess, and
the optical disk placement portion and the protruding portion of the turntable are made of a magnetic metal plate integrally by a drawing process, and a drive shaft of the motor is pressed to fit in and fixed to the turntable.

2. An optical disk drive for recording or reading data on an optical disk by irradiating the optical disk with a laser beam, comprising:
a turntable for placing and rotating the optical disk;
a clamp for holding the optical disk in such a way that the optical disk is sandwiched between the turntable and the clamp; and
a motor for driving the turntable to rotate, wherein
the turntable, which is structured to press the recording face side of the optical disk so that the optical disk is sandwiched between the clamp and the turntable when the optical disk is inserted, includes an optical disk placement portion for placing the optical disk, a protruding portion that protrudes from the center of the optical disk placement portion, and a plastic holding portion that is fixed to the outer face of the protruding portion and engages a center hole of the optical disk, a plurality of bosses provided to the holding portion are inserted into a plurality of boss holes provided to the optical disk placement portion, and tip portions of the bosses are fused so that the holding portion is fixed to the optical disk placement portion,
the clamp includes a presser portion with a pressing face that contacts with a side of the optical disk opposite to the side that contacts with the turntable, an engaging recess that engages the holding portion and a ring-like damper magnet that is fixed to the engaging recess, and
the optical disk placement portion and the protruding portion of the turntable are made of a magnetic metal integrally, and a drive shaft of the motor is pressed to fit in and fixed to the turntable.

3. The optical disk drive according to claim 2, wherein the optical disk placement portion and the protruding portion of the turntable are made of a magnetic metal plate integrally by a drawing process.
